(19) United States
(12) Patent Application Publication
(10) Pub. No.: US 2010/0332496 A1
(43) Pub. Date: Dec. 30, 2010

(54) IMPLICIT PRODUCT PLACEMENT LEVERAGING IDENTIFIED USER AMBITIONS

(75) Inventors: Eric Horvitz, Kirkland, WA (US); Brett Brewer, Sammamish, WA (US); Melissa W. Dunn, Woodinville, WA (US); Janet Galore, Seattle, WA (US); Abhiram G. Khune, Sammamish, WA (US); Sin Lew, Bellevue, WA (US); Timothy D. Sharpe, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/492,506

(22) Filed: Jun. 26, 2009

(51) Int. Cl. G06F 17/30

(52) U.S. Cl. 707/759; 707/769; 707/723

(57) ABSTRACT

The claimed subject matter provides a system and/or a method that facilitates accessing information content based at least in part on relevancy to a user by leveraging user ambitions. User ambitions can take the form of to-do lists, calendar items, goals, or interests. These can be leveraged with or without contextual information, historical data, user profiles, and the like to determine the relevancy of content to a specific user. This can facilitate determining what content is accessible to a user based on relevance. A threshold relevance level can be dynamically adjusted.

### BACKGROUND

Advances in computer hardware and software are enabling computing systems to undergo a transformation in personalization of applications and systems to individual users' likes and dislikes. Further, advances towards massive data storage capacities, extreme computational power, super high speed networking and widely distributed computing environments all contribute to an almost unlimited amount of data available almost instantly on almost any computing device anywhere in the world. One example in this progression is the advent of high speed internet searches and data access on mobile computing devices such as smart phones.

Historically, computer systems have experienced a proliferation in features and functions that correlated roughly with advances in memory and computational power. Comparing early video games to modern video games provides a clear illustration of the improved user experience associated with increased memory and processing power. Of the many advanced features found in these exemplary computing systems, personalization of the application is not to be overlooked. In video games this personalization could include recording game settings for individual users across gaming sessions, personalized avatars, custom mapping of control devices, or other features that adapted the gaming experience to the user to improve that experience or provide some advanced feature that the user community found valuable.

Similar advances in personalization can be seen in other computer systems and products. Cookies, for example, have empowered internet services to adapt to individual computer systems or individual users. Even operating systems can be adapted to individual user preferences, for instance, by associating a user profile to a log in name. Modern mobile devices such as smart phones, PDA's, and the like, similarly can be personalized, such as by selecting how often a device synchronizes, aggressiveness of a power saving schema, availability of services or applications, and the like, on a user by user basis at a level that far surpasses early cell phones and electronic calendar devices.

Personalization of data and information is also becoming more and more prevalent as computing power and communication power increases. For example, many modern internet search engines allow personalization of search filters, for instance, to limit retrieval of mature material, limit searches to select databases, limit searches to certain languages, and the like, frequently on a user by user level of personalization. As another example, user customizable internet portals allow a user by user customization of an entry point to the internet by, for example, customizing news content displayed there, automatically logging into user selected email accounts, etc.

Traditionally, information content and advertising has been directed at consumers with very little adaptation to the user on an individual basis. Albeit that information content is frequently adapted to select groups, these adaptations are then generally pushed to target groups rather than to individuals. For example, advertisements for a car can have very different advertisements pushed to viewers of daytime television as compared to viewers of a sporting event or prime time news program. Despite the ads being tailored to the generalized expected viewer (or listener, depending on the advertising medium), the advertisements are generally not adapted to individual customer's preferences. Similarly, information is generally filtered at only a basic level in traditional systems and rarely contemplates a user's historical profile, context, ambitions, and the like. For example, an RSS feed can incorporate some level of filtering but conventionally would not change the feed based on a user's location, activity, or schedule. Modern conventional computing systems have not traditionally employed improved information and advertising systems that account for individual user personalities in facilitating the ambitions of individual users.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates generally to information content access systems and/or methods (e.g., content systems and/or methods). More particularly the disclosed subject matter relates to systems and/or methods that facilitate adaptive anticipatory content access leveraging identified user ambitions. These identified user ambitions can be employed in determinations or inferences related to the relevance of content made available to the user. This can provide an improved user experience with regard to the relevancy of information as it relates to facilitating the goals and tasks associated with a user. Further, these systems and methods can improve the value of advertising to advertising content providers by inherently being adapted to not only the target user, but to the preferences and ambitions of a specific targeted customer. This improved value can be leveraged to provide additional benefit to the advertiser or customers. For example, a user with a scheduled flight to France can be given additional pricing incentives for tours around Paris as compared to other more generalized advertising for the same tours to a more general audience that may not even be planning a trip to France. This targeted adaptive and anticipatory content access can in turn result in higher advertising conversion rates for any given set of advertising.

Where memory, connectivity and computational power continue to improve, user customization of nearly every aspect of interaction with a computing device or service is expected to become common place and every computer interaction will likely consider the user's “goals” in the interaction. For example, where a user is planning a dinner date, a computer system can anticipatorily engage the user with information content on restaurant reviews for intimate dining, advertising directed to romantic dinner packages, or news of evening entertainment venues. Similarly, where a user is a huge fan of a popular sports car, the computing device can be expected to rank news stories, video of the car, or special pricing related to the car as more important to the user than information related to a sedan, such that the sports car information is more likely to be communicated to the user as the user interacts with the computing device.

In accordance with an aspect of the claimed subject matter, an information content source can comprise information content that can be made accessible to a user. Access can be through a user device which can also be a mobile device. For example, a user device can be a personal computer, an information kiosk, a smart phone, a radio device, a netbook computer, a laptop computer, a GPS system, or any other device that can serve to facilitate a user accessing at least a portion of the content of an information content source. The information content source can be a content component. In an aspect, the content component can be a source of general content. In another aspect the content component can be a source of content that already reflects some degree of specificity to a user. For example, a general content source can be the internet, a dictionary, or libraries of advertising content. Also for example, more specific content can be an RSS feed based at least in part on user criteria, or advertising directed to a market sector related to the user. One of skill in the art will appreciate that a nearly limitless number of information content sources (e.g., content components) exist and that all are considered within the scope of the subject matter despite not being explicitly enumerated herein.

In accordance with an aspect of the disclosed subject matter, a relevancy can be determined or inferred for the content for a specific user or group of users. For example, a relevancy component can determine that vaccination information content is relevant for a family traveling to Mexico. As another example, it can be inferred that advertising content for an upcoming book reading is relevant to a user that owns a number of the author's other works. One of skill in the art will appreciate that numerous inferences and determinations can be formed as to the relevancy of content to a user or group of users.

In an aspect, ambitions can be determined or inferred for a user or group of users. These ambitions can then be leveraged in determinations and inferences related to the relevancy of content to a user or users. For example, an ambition can be a goal, task, to-do item, calendar object, bookmark, purchase, preference, or other indication related to an ambition of a user or users. One of skill in the art will appreciate that ambitions can be of varying temporal frames (e.g., long term, short term, ongoing, one time, multiple occurrence, . . . ), of varying levels of importance (e.g., must do, should do, can do, may do, could do, don't want to do, or be of varying spectra (e.g. interest, goal, enumerated item in a list, . . . ), and that all such ambitions are within the scope of the disclosed subject matter.

As an example, a user can be associated with a to-do list item such as “buy milk” (e.g., buying milk is an ambition of the user). Information content can include an advertisement for milk at a local grocery chain that is on sale. Where the user is driving near the grocery on the way home from work, it can be determined that it is relevant to the user to display the milk special to the user on the user's GPS. While traditionally, the user might have to read print advertising to find the sale on milk, and would have to know of the location of the store near their route home from work to take advantage of the milk sale, the user in this example can then benefit from the anticipatory content access and can buy the milk for a sale price at a location near their current route with little thought given to what is on sale or where it is on sale. In an alternative form of the same example, it can be inferred that where the user is running late on the way home from work, the ad for milk is less relevant because it would delay the user's arrival at home until after their spouse typically arrives home. One of skill in the art will appreciate that the huge number of factors that can be incorporated into determinations and inferences relating to user ambitions and content relevancy can provide for extremely intricate models and that all such factors are within the scope of the disclosed subject matter. This will be especially appreciated in light of the ever increasing capabilities of computing systems and the anticipated improvement in performance of the innovations herein disclosed when operating on such advanced computing platforms.

In an important further aspect, a privacy component can be employed at one or more levels of the disclosed subject matter to protect user information from being disseminated improperly. This serves to not only simply keep private information private, but further reinforces a user's confidence in the adaptive and anticipatory content access system such that they are willing to entrust such systems with more accurate and personal information than they would for an untrustworthy or unscrupulous system. This additional data can be employed to improve the performance of these types of systems. This sensitive type of data may not be available without implementation of privacy standards through a privacy component.

In accordance with another aspect of the claimed subject matter, the information content can be selectively accessed based at least in part on a user's preferences. A user profile can facilitate determinations or inferences related to the relevancy of content for user access. As an exceedingly simplistic example, if advertising content is related to a five-star steakhouse and the user is vegan (e.g., it is explicitly or implicitly indicated in a user profile that the user does not consume animal products) it can be determined that the steakhouse advertising is not relevant for the user. Similarly, another user can selectively be presented with special discount advertising for the same steakhouse where they enjoy steak frequently at a competing restaurant because it is determined that this advertising content is highly relevant to this particular user. Where additional preferences and user selections can be considered, the relevancy of information content can become increasingly adapted to particular users as will be appreciated by one of ordinary skill in the art.

In another aspect, content can be stored locally or remotely and accessed through a communications framework. For example, where huge libraries of advertising content can be stored on a memory component of a Smartphone, determinations of relevancy can facilitate direct user access to that content on the Smartphone with less onerous privacy measures because user information remains local to the Smartphone. Alternatively, or in addition, information content can be widely distributed across a network, such as the internet, and such content can be accessed where it is relevant or to determine relevancy. For example, where a user desires to go to Las Vegas in December, the airline, hotel, and casino databases can be crawled to determine if they contain relevant information content that can be presented to the user. This information can be made available to a user across a communications network such as at a computer over the internet or on a cell phone by text message over an SMS (short messaging system) network. One of skill in the art will appreciate that determining relevancy in a distributed manner can imply a greater need for employing privacy components to protect a user's personal information.

In another aspect, a user can explicitly or implicitly indicate a contextual bookmark. A contextual bookmark can capture contextual information related to the user at a point in time. For example, where a user is talking to a friend about his new shoes, a contextual bookmark can include a digital snapshot of the shoes. This contextual book mark can then be leveraged to facilitate access to relevant information content. Continuing the example, information on the shoes can be sought out and presented to the user, for instance, that the shoes are on sale, that the shoes are similar to other shoes that are available nearby, that the shoes have many poor reviews for comfort, etc. One of skill in the art will appreciate that a contextual bookmark can be a powerful tool to direct relevancy determinations and/or inferences and that any contextual bookmark employed to gather content based on relevancy or to determine relevancy is within the scope of the disclosed subject matter.

In an additional aspect, a related task list component can facilitate additional facets of relevancy determinations. A related task list can be a list of tasks related to an ambition, which ambition can be indicated by a particular user. For example, where an ambition can be “paint the house”, a related task list can include, for example, “select paint color”, “power wash house”, “sand house”, “prime house”, “paint house”, “apply second coat”, etc. Where a user indicates that they will paint their house in spring, the related task list can be leveraged to determine the relevancy of information content that can be made accessible to the user. For example, the user can calendar painting the house in June, and in response, an informational video on house painting from the internet can be suggested to the user. Further, calendar items can be suggested for renting a power washer a week before painting to facilitate stripping the old paint per the related task list. Additionally, an advertisement for a color consultant can be made available to the user to help them select a new color for the house several weeks before the paint job is scheduled. Further, non-obvious events can be surfaced for the user. For example, where a housing development review board must approve the house color choice, the user can be reminded of this obligation in a timely manner to facilitate submitting selections for the review board to enable house painting on the scheduled ambition date.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates access to information content based at least in part on relevancy to a user.

FIG. 2 illustrates a block diagram of another exemplary system that facilitates access to information content based at least in part on relevancy to a user, further including a privacy component.

FIG. 3 illustrates a block diagram of an exemplary system that facilitates access to information content based at least in part on relevancy to a user, further including a user profile component.

FIG. 4 illustrates a block diagram of another exemplary system that facilitates access to information content across a communications framework based at least in part on relevancy to a user.

FIG. 5 illustrates a block diagram of an exemplary system that facilitates access to information content based at least in part on relevancy to a user, further including a contextual bookmark component.

FIG. 6 illustrates a block diagram of an exemplary system that facilitates access to information content based at least in part on relevancy to a user, further including a related task list component.

FIG. 7 illustrates an exemplary methodology that facilitates accessing information content based at least in part on relevancy to a user.

FIG. 8 illustrates another exemplary methodology that facilitates accessing information content based at least in part on relevancy to a user.

FIG. 9 illustrates an exemplary methodology that facilitates accessing information content based at least in part on relevancy to a user and relative to related tasks.

FIG. 10 illustrates another exemplary methodology that facilitates accessing information content based at least in part on relevancy to a user relative to contextual bookmarking.

FIG. 11 illustrates an exemplary networking environment, wherein the novel aspects of the claimed subject matter can be employed.

FIG. 12 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “manager,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

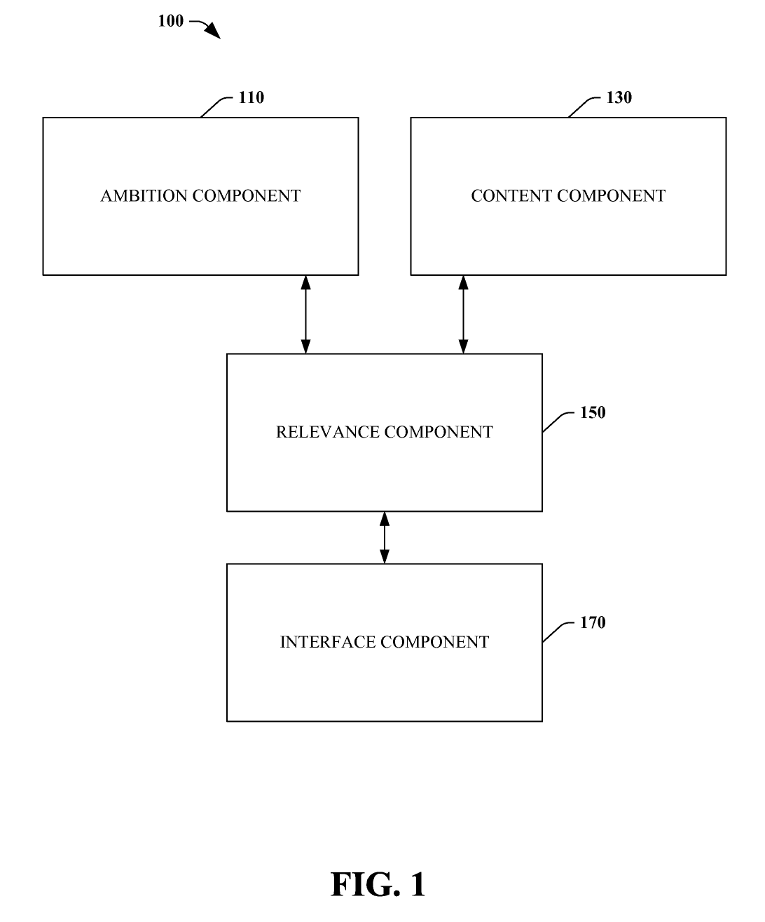

Now turning to the figures, FIG. 1 illustrates a system 100 that facilitates access to information content based at least in part on relevancy to a user. Determining or inferring relevancy can be related to user ambitions. System 100 can include an ambition component 110. Ambition component 110 can relate information related to a user ambition(s) to other component(s) of system 100. User ambitions can include goals, to-do items, interests, intents, calendar items, etc., that relate to ambitions of a user. For example, a user can have a to-do list containing a plurality of user ambitions, a calendar containing several additional ambitions, and an online book list representing more ambitions. Moreover, an ambition can be explicit or implicit. For example, an explicit ambition can be “run a 5 km race by next June”, while an implicit ambition can be “buy new running shoes” to train for the 5 km run. As another example, an implicit ambition need not be tied to an explicit ambition, for instance, an implicit ambition can be “buy milk” where a user has run out of milk at home but has not explicitly indicated that more milk should be purchased (e.g. it can be inferred that the user will want more milk and that “buy milk” is thus a likely ambition of the user.)

In an aspect, ambition component 110 can be a repository of user ambition content. This repository can be a single repository or a distributed repository. Further, the repository can include ambition content stored in any format amenable to computer system access (e.g., electronic database, flash memory, optical disk, RAM, ROM, combinations thereof, or any other storage format that would facilitate access by a computer as will be appreciated by one of ordinary skill in the art.) The ambition content can be of a plurality of formats and types (e.g., to-do lists, calendar objects, tables, databases, etc.) One of skill in the art will appreciate that nearly a limitless number of types and forms of data can be construed to relate to a user ambition and that all such forms and types are within the scope of the disclosed subject matter. It will be further appreciated by one of skill in the art that any storage or access means to these types and forms of data are also within the scope of the art even where not explicitly enumerated herein.

In an aspect a user ambition can be a context sensitive goal (e.g. buy milk at the grocery, read a presentation during a flight, paint the windows in summer when it is not raining, etc.) In another aspect a user ambition can be an objective of a user (e.g., take a trip to Brazil, run a 5 minute mile, ski the Alps, climb K2, etc.) In a further aspect a user ambition can be a user interest (e.g., gather information about salt water aquariums, learn about raising wine grapes, etc.) In a still further aspect a user ambition can be a task or sub-task (e.g., check email after lunch, reply to all high importance emails first, upload presentation to the server, verify upload to server, etc.) In yet another aspect, a user ambition can be tangential opportunities (e.g., things to do after a dinner date, gathering supplemental information relating to a home repair project, etc.) One of skill in the art will appreciate that these ambitions and others can be combined and represented in a nearly limitless number of combinations and that all such permutations are considered within the scope of the disclosed subject matter.

In an aspect the ambition component 110 can facilitate access to information that can be leveraged to help a user achieve an ambition. For example, a user ambition can be leveraged to help a user do what they want to do, e.g. at a very simplistic level, enable a solution-centric schema, for instance, presenting a user with information that milk is on sale at a nearby store where the user has indicated that milk is needed (e.g., the ambition of getting milk can be facilitated to present the user with options for fulfilling the ambition of buying milk.) Facilitating achievement of user ambitions can be relevancy sensitive. For example, where a user ambition is to buy milk, information about milk is more relevant when that milk is on sale, is a preferred brand, is proximate to the user, is available on the way home, etc. Similarly, information related to achieving the user ambition to buy milk would be less relevant to the user when the user is leaving town on a business trip, is at a client meeting despite being near a store, the amount of the milk is not of a preferred volume, etc. Thus, user ambitions can be leveraged to facilitate achieving a user ambition in a context sensitive manner to improve relevancy.

System 100 can further include a content component 130. Content component 130 can facilitate access to information content. Information content can be any form or type of information content. For example, information content can be advertising content and/or instructional content, for instance an advertisement on how to user a software product for backing up a computer can be both instructional and form of advertising. Similarly, for example, information content can be audio and/or video content, for instance a podcast or online video. One of skill in the art will appreciate that information content can be of nearly any type or form and that all such content is within the scope of the disclosed subject matter. Further, one of skill in the art will appreciate that the vast volumes of information content in traditional systems and methods can be an impediment to a user seeking to find or access relevant content.

System 100 can further include relevance component 150. Relevance component 150 can be communicatively coupled to ambition component 110. Relevance component 150 can be similarly communicatively coupled to content component 130. Relevance component 150 can facilitate determining and/or inferring the relevancy of content for a user. Relevance component 150 can comprise an inference component (not illustrated) and/or an artificial intelligence component (not illustrated) for forming inferences as disclosed herein. Ambition information can be leveraged by the relevance component 150 to improve determinations or inferences of relevancy for content to a user. For example, where a user has an ambition of “buy new cell phone”, the relevancy component can facilitate access to advertising content related to new cell phones available near a user because these advertisements can be determined to be relevant to the user based in part on the user ambition information.

In an aspect, relevancy component 150 can employ contextual data, historical user data, user profiles, user privacy concerns, combinations thereof, and other such data sources to facilitate determinations or inferences relating to the relevancy of content to a user. For example, where a user historically rents a sedan on business trips, and has indicated a preference for convertibles during sunny weather, this information can be employed to determine that in the context of a business trip in Florida during a sunny period, it is relevant to facilitate access to information about renting both sedans and convertibles. Similarly, where the business trip is in Seattle in February, it can be inferred that only rental information pertaining to sedans is relevant given the high likelihood of inclement weather. One of skill in the art will appreciate that numerous data sources can be accessed in determining or inferring relevancy and that all such data sources are to be considered within the scope of the present disclosure.

System 100 can further include an interface component 170. Interface component 170 can enable a user to access content exceeding a predetermined level of relevancy. This predetermined level of relevancy can be dynamic and can be interactive. For example, where a user's context changes from a work environment to a vacation environment, the level of relevancy can dynamically adjust to facilitate access to an different subset of content that is relevant to a user, for instance information on a tour of a castle may not be sufficiently relevant at work but can be sufficiently relevant while on vacation in Europe. As an additional example, a user can explicitly or implicitly adjust a relevancy threshold level, for instance, by repeatedly dismissing suggested articles about Monet paintings, it can be implied that Monet paintings are of less relevance and that the threshold for Monet painting articles can be raised. One of skill in the art will appreciate that any adjustment of threshold relevancy levels is within the scope of the disclosed subject matter.

In an aspect, system 100 can facilitate user access to information content to help users achieve their ambitions. System 100 can incorporate determinations and inferences related to user ambitions as an input to a relevance component 150. Further, determinations and inferences relating to the relevance of content to a user can be improved by incorporating ambition information. Similarly, employing information(s) related to context, history, profiles, preferences, and the like can enable improved relevancy determinations and inferences. System 100 can assist a user towards achieving a goal by selectively facilitating access to information relevant to achieving a goal. Further, system 100 can employ relevancy determinations and inferences to not only increase the flow of relevant information but reduce the flow of irrelevant or less relevant information to a user. Similarly, where relevancy is dynamic as disclosed for system 100, information that is sufficiently relevant in any particular situation or context can be presented to or accessed by a user, e.g., information that is less relevant in said particular scenario can be held back from a user where it is not sufficiently relevant therein. This can result in an optimization of information presented to a user such that ambitions can proactively be included in a relevancy calculus to present a user with the best information at the best time. This description is not presented to limit the disclosed subject matter and is only intended to provide a general impression of the related aspects of the innovation.

As an example, where a user indicates “buy milk”, it can be deemed to be most relevant to present information relating to buying milk to when the user is returning to their home, passing within a block of a grocery, the milk is at least 10% cheaper than the average price the user paid historically, etc. Thus, an ad for a buy one get one free milk sale at a local grocery on the way home for the user can be presented to the user on their cell phone as they are heading to the car after getting off work rather than being presented to the user when they are going into work and would be less likely to have a place to store the milk. This simplistic example clearly illustrates that relevancy of information can be dynamic and that systems such as system 100 can facilitate access to information relevant to achieving the users ambitions in a dynamic manner. What is relevant to a user can be related to data mined from user actions, decisions, and schema. In an instance, user relevancy can be explicit, such as a user profile entry that the user is vegan. In another instance, user relevancy can be implicit, such as, implying a vegan lifestyle by accessing a particular vegan grocery website or data source tailored to vegans. One of skill in the art will appreciate that volumes of data can be captured and associated to a user and that all such information can be employed in forming a user profile that can facilitate determining relevancy of advertising content to a user. All such profile techniques or methods of determining relevancy are within the scope of the disclosed subject matter as it relates to selectively accessing information content. Further, it will be appreciated that privacy concerns are likely to arise and that the disclosed subject matter considers these issues as is disclosed herein.

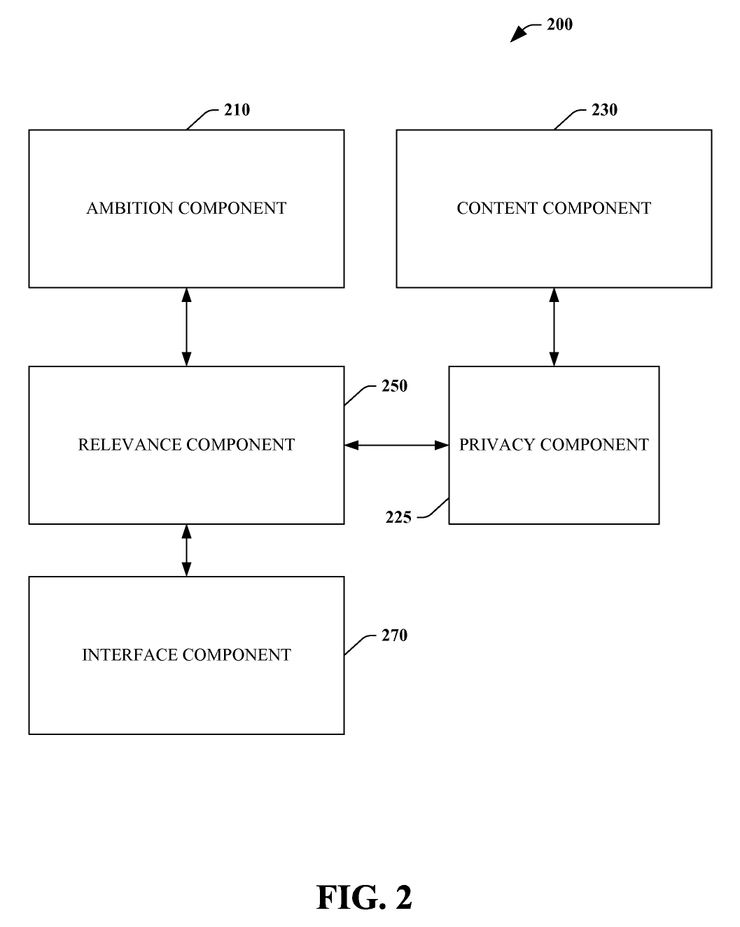

FIG. 2 illustrates a system 200 that facilitates access to information content based at least in part on relevancy to a user. System 200 can be the same as or similar to system 100. System 200 can include an ambition component 210 that can be the same as or similar to ambition component 110 of system 100. System 200 can also include a content component 230 that can be the same as or similar to content component 130 of system 100. System 200 can further include a relevance component 250 that can be the same as or similar to relevance component 150 of system 100. System 200 can still further include an interface component 270 that can be the same as or similar to interface component 170 of system 100.

In an aspect, system 200 can further include a privacy component 225. Privacy component 225 can be disposed between content component 230 and relevance component 250 to assist in protecting user sensitive information from undesired dissemination. For example, where content component 230 includes an advertising database for a car company, and the user has an ambition to purchase a sports car from said car company, it can be determined that information about the car company's sports cars is relevant. However, a user may not desire that this information be given directly to the car maker. As such, in this example, privacy component 225 can seek information from the car maker in a manner that does not divulge identifying information about the user to the car maker.

As a further illustrative example, privacy component 225 can employ searching algorithms to inspect content or data submitted by the car maker in response to a query or search. The inspection can employ programmatic detection algorithms, such as algorithms employed to detect viruses, spyware, Trojan horses, or other programmatic malware. Accordingly, privacy component 225 can be configured to mitigate data mining from content sources or third party data feeds (e.g., the car maker, an internet data store, a website, an advertisement or coupon data store) obtained by system 200 in conjunction with adaptive and anticipatory content access, described herein.

The inclusion of a privacy component 225 illustrates observance of the serious nature of safeguarding user ambitions and relevance data. Where users feel that care is not taken with regard to personal data, they can often feel that a service or product is untrustworthy. This can result in users deploying false or misleading data, providing limited data, or seeking alternative products and services that may not serve them as well. In each case, the loss of trust results in an inferior experience for a user. For example, where a user plans a trip to Mexico and could benefit from relevant information related to travel warnings, hotel specials, and tours, such relevant information may not be available where the user either neglects to provide relevant information, intentionally refuses to provide such information, or provides misinformation such as merely calendaring “staying home for a week” rather than “going to Mexico for vacation”.

Where a user's data is protected by a privacy component 225, increased trust can result. Where increased trust occurs, users can be expected to provide more and better information. This information can then facilitate improved accuracy in relevancy determinations. Improved relevance can benefit the user in more focused and useful information, reduced irrelevant information, increased value in advertising (e.g. increased savings, less volume of advertising, . . . ), or combinations thereof among many other benefits as will be appreciated by one of skill in the art. This general disclosure related to the benefits of user privacy through a privacy component is not presented to limit the scope of the disclosed subject matter. One of skill in the art will appreciate that a myriad of techniques and systems can be employed to effectuate a privacy component 225 and that the particular manner of effecting the privacy component 225 is not the focus of the disclosed subject matter as contrasted with the benefits of employing an effective privacy component 225. Thus, one of skill in the art will appreciate that any and all means for protecting the privacy of user data and any and all privacy components 225 are within the scope of the disclosed subject matter.

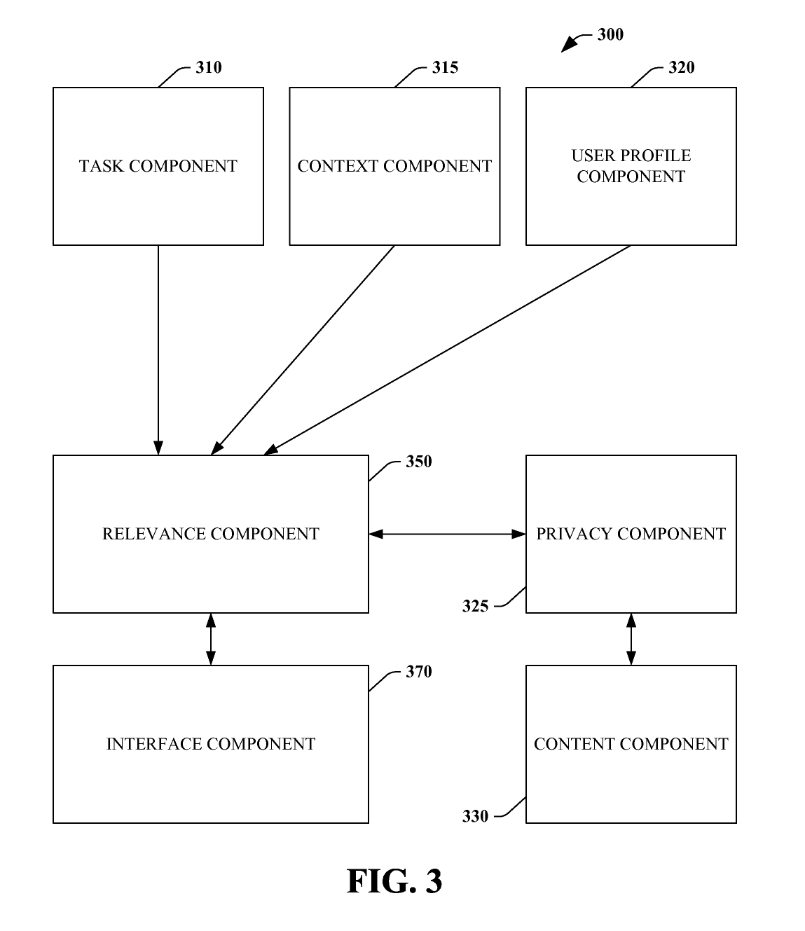

FIG. 3 illustrates a system 300 that facilitates access to information content based at least in part on relevancy to a user. System 300 can include task component 310. Task component 310 can be a more specific type of ambition component 210 or 110 as disclosed herein. A task component 310 can include a list of enumerated tasks for a user. For example, task component 310 can include a to-do list or other task list. In an aspect, a task list can include user ambitions. For example, a user ambition of a task list can be “upload report to central server”. One of skill in the art will appreciate that numerous user ambitions of a nearly limitless number of types and forms can comprise a task list and that all are within the scope of this disclosure. As disclosed herein, a task list can also include explicit and implicit user ambitions, for instance, related tasks, complimentary tasks, etc. As an example, where a to-do list includes “upload file to central server”, a related task can be “get sever password from administrator”. Thus, even where getting the password is not explicitly in the list, it can be included implicitly.

System 300 can further include context component 315. Context component 315 can provide contextual information to enable improved determinations of relevancy. For example, where a user is driving, a context component 315 can include GPS data of the user's position (e.g., a cell phone or GPS device can source location data related to the user.) As another example, a context component 315 can relate a user's current computer interactions (e.g., data about a user's current computer interactions can be sourced to a relevancy component to facilitate relevancy computations.) In a further example, a context component 315 can mine user behaviors and actions; for instance, information can be culled from a telephone conversation, objects a user is looking at can be determined from computations related to the line of sight, etc. One of skill in the art will appreciate that a nearly limitless number of sources of context can be included in context component 315 and that all are considered within the scope of the current disclosure.

System 300 can also include user profile component 320. User profile component 320 can facilitate an explicit and/or implicit user profile that can provide information for relevancy determinations or inferences. User profile component 320 can include one or more user profiles. User profiles can include historical user data. Further, user profiles can include user directed preferences. One of skill in the art will appreciate that a user profile can provide information that can be leveraged in determinations or inferences relating to the relevancy of content to a user and will further appreciate that any and all such user profiles are within the scope of the disclosed subject matter.

In an aspect, task component 310, context component 315, and/or user profile component 320 can be communicatively coupled to relevance component 350 of system 300. Relevance component 350 can be the same as or similar to relevance component 250 or 150 of systems 200 and 100 respectively. The communicatively coupled components can provide sufficient data to form at least one determination or inference related to the relevancy of content to a user. As will be appreciated by one of ordinary skill in the art, typically the more rich and contiguous a set of data is for a given model, the more useful the modeled result and thus, it is anticipated that rich and voluminous data sources are presented by task component 310, context component 315, and user profile component 320 to proved highly granular data for modeling relevancy. It will be further appreciated that these highly data intensive systems are within the scope of the disclosed subject matter. This assumption is not however given to be limiting; any data source for relevancy determinations or inferences is also considered to be within the current scope.

Content can be accessed from content component 330 that can be the same as or similar to content component 230 and 130 as disclosed herein. Similarly, content can be accessed from content component 330 by way of a privacy component 325, which can be the same as privacy component 225 as also disclosed herein. System 300 can further include an interface component 370 that can be the same as or similar to interface component 270 or 170 of systems 200 and 100 respectively.

As an example, system 300 can be included in a Smartphone device and can include at least one to-do list. The Smartphone can further include a browser history and a GPS data source. The exemplary user device can include a relevance component that can analyze the to-do list to at least in part determine the relevancy of ads pushed to the Smartphone internet browser. In addition, the user's current position and previous internet search history can also be leveraged in relevancy determinations.

As a more specific example, where the user lists “buy new watch” on the to-do list, is driving by a watch shop that carries Brand X watches and has been viewing Brand X watches in internet searches for the past two weeks, it can be determined that ads for Brand X watches for the nearby retailer are highly relevant. Where there are ads meeting the above criteria, they can be pushed to the user's cell phone display to help the user fulfill the ambition to purchase a Brand X watch. For instance, an ad could be pushed to the user stating, “You're 1 block from your dream Brand X watch, stop today and get an additional 10% off or come back later and still get 5% off at Jonny's watches!” Where the user indicates that they are late for a meeting, information can be pushed backed to the retailer (through the protocols of the privacy component 325) indicating that the user is interested but not sufficiently enticed to purchase. This information can be used by the advertiser to improve future advertising. One of skill in the art will appreciate that this simplistic example is not intended to be limiting and that it only represents one narrow example of the types of relevancy determinations that can be formed to assist a user in achieving an ambition. One of skill in the art will appreciate that other more complex example can be formed based at least in part on aspects of the disclosure and that all such examples are considered within the present scope of the disclosed subject matter though not explicitly illustrated herein.

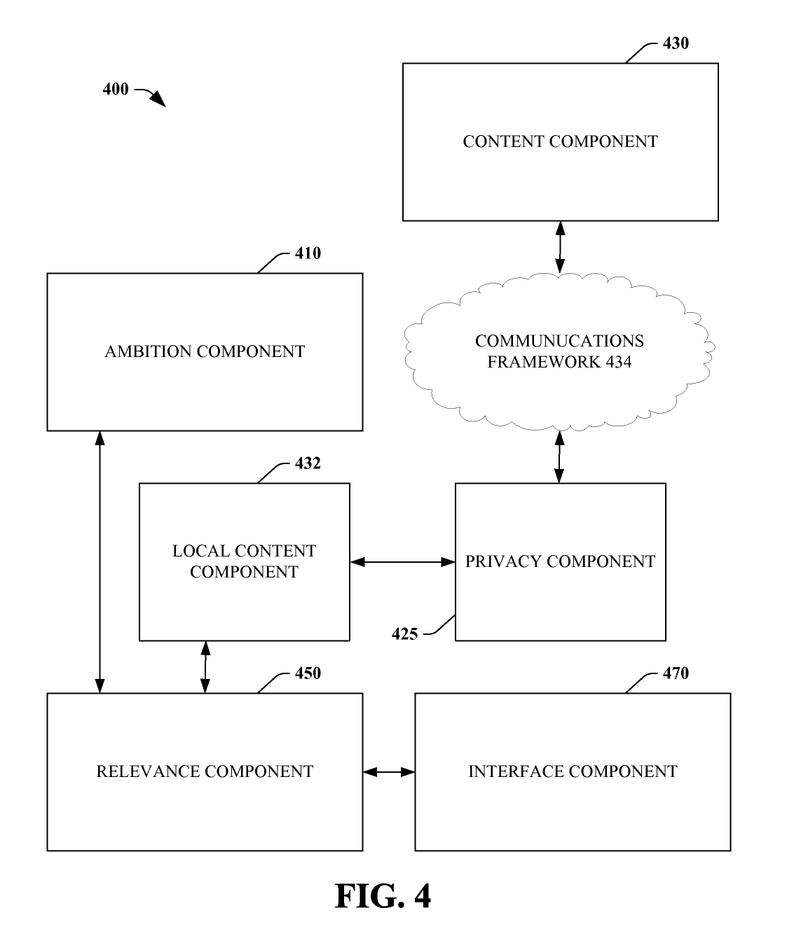

FIG. 4 similarly illustrates a system 400 that facilitates access to information content based at least in part on relevancy to a user. System 400 can be similar to system 300, 200 or 100. System 400 can include ambition component 410 that can be similar to ambition component 210, 110 or task component 310 as disclosed herein. System 400 can further include a privacy component 425 that can be the same as 325 or 225; relevance component 450 that can be the same as or similar to relevance component 350, 250 or 150; and interface component 470 that can be the same as or similar to interface component 370, 270 or 170 as disclosed herein.

System, 400 can further include content component 430. Content component 430 can be the same as or similar to content component 330, 230 or 130 from systems 300, 200 or 100 respectively. As illustrated in FIG. 4, content component can be communicatively coupled to the remainder of system 400 through a communications framework 434. Communications framework 434 can be a wired or wireless communications framework (e.g., LAN, cellular network, WAN, Wi-Fi network, radio broadcast, satellite link, combinations thereof . . . ). One of skill in the art will appreciate that the precise form of the communications network is irrelevant where the framework is at least capable for communicating information related to content to the other components of system 400 and that all such communications frameworks are within the present scope.

System 400 can also include a local content component 432. Component 432 is described as local merely to illustrate the relative position with regard to content component 430. As illustrated, content component 430 and local content component 432 are disposed across at least a communications framework 434. Where content component 430 is also local, there may be little distinction from local content component 432 other than content component 430 being communicatively coupled through communications framework 434.

For example, content component 430 can be a corporate server having video content thereon. Content component 430 can be communicatively coupled across a communications framework 434 comprising, for example, the internet and a cellular network. Video content from content component 430 can be communicated across framework 434 and be cached on a local content component 432 included in a user device comprising aspects of system 400. This can facilitate storing local copies of content from a variety of external content components 430 (not illustrated). This type of system can store general content or specific content, wherein specific content is defined as content already determined or inferred to be in at least in some manner more relevant to the user than general content. For example, a local component 432 can cache specific content related to Brand X watches from an earlier example. One of skill in the art will appreciate that it is anticipated that the local content component 432 can include massive storage capabilities and that a nearly limitless amount of data can be stored locally to facilitate relevancy determinations, these types of storage are within the scope of the disclosed subject matter.

In another example, content component 430 need not be disposed at a great distance. In an example, content component 430 can be a local hard drive accessed across a local network. Alternatively, for example, content component 430 can be a flash drive accessed across a bus communications framework. In yet another example, content component 430 can be a memory within a chip also comprising local content component 432 such that content component 430 and local content component 432 are disposed across a communications framework for the chip itself. One of skill in the art will appreciate the distinction between content component 430 and local content component 432 at some level is semantic but that generally, multiple content sources can be included in system 400 and can be local or remote and that call such sources are within the scope of the subject disclosure.

Privacy component 425 can also be disposed between content component 430 and local content component 432. This can facilitate accessing content in a manner that preserves a user's desired level of privacy. For example, a cache of watch information for a plurality of brands can be taken from a jeweler's server (e.g., content component 430 is a jeweler's server) and stored locally. The user can then access just Brand X watch data locally without divulging to the jeweler which particular brand of watches are most relevant to the user. For instance, user relevancy information can be restricted to the local system by privacy component 425. Numerous other examples of different privacy protection methods can be illustrated but are not included herein for brevity where one of ordinary skill in the art will appreciate that all such privacy schema are within the present scope.

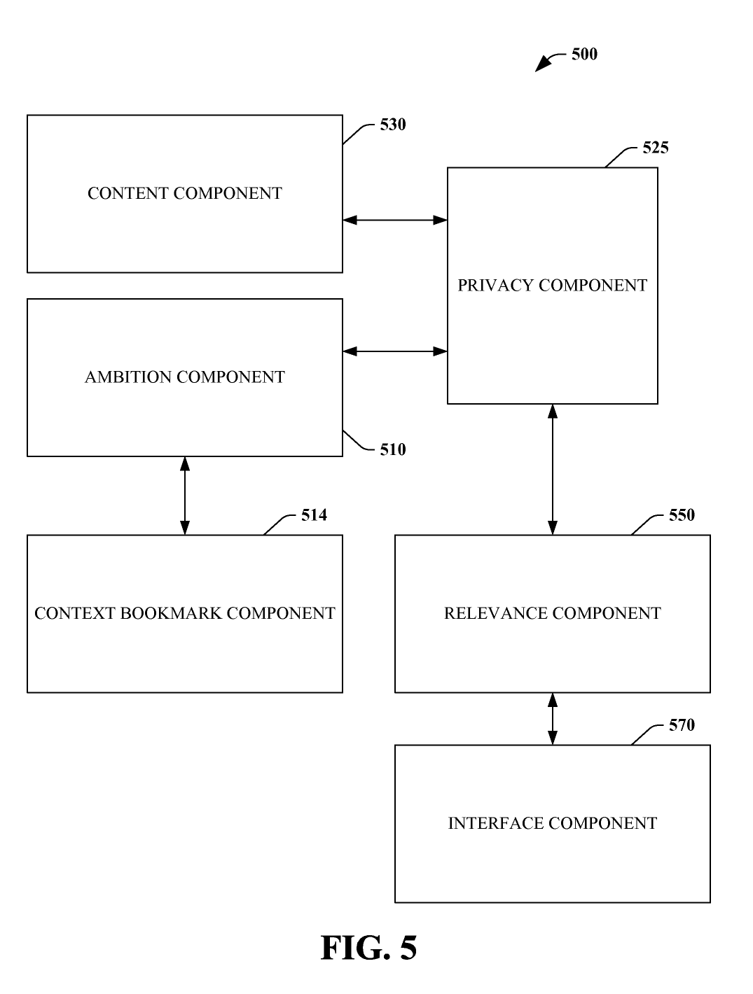

FIG. 5 illustrates a system 500 that facilitates access to information content based at least in part on relevancy to a user. System 500 can include ambition component 510 that can be similar to ambition component 410, 210, 110 or task component 310 as disclosed herein. System 500 can further include a privacy component 525 that can be the same as 425, 325 or 225; content component 530 that can be the same as or similar to content component 430, 330, 230 or 130; relevance component 550 that can be the same as or similar to relevance component 450, 350, 250 or 150; and interface component 570 that can be the same as or similar to interface component 470, 370, 270 or 170 as disclosed herein.

System 500 can further include context bookmark component 514. Context bookmark component 514 can include user triggered indication(s) of context. The trigger can be a conscious trigger, or a semi or unconscious trigger (e.g., a physical impulse). For instance, a user can cause a context bookmark to be formed. This context bookmark can relate to contextual information that can be accessed at a later time. The accessed information can them be employed in relevancy determinations as disclosed herein. Context bookmarking can facilitate users actively selecting context tokens that are regarded as highly relevant.

Context bookmarking can further facilitate unconscious or semi-conscious indications of user experiences that can be used to infer relevant activity or ambitions. For instance, a user impulse or reaction can be mapped to a particular sentiment, which can be indicative of a type of stimuli the user is experiencing. The particular sentiment (e.g. approval, happiness, anger, defensiveness) can often be a strong indicator of relevance. As an example, consider a user that often emits a nervous laugh when approached by a person he/she is attracted to. Detection of the nervous laugh could be utilized as a context bookmark for that user, indicating context and relevance (e.g. attraction to another human being) in a particular moment. It should be appreciated that an impulse context bookmark can be mapped to a user sentiment explicitly specified by the user, implicitly through artificial intelligence, specified by an associate, friend, spouse, etc., of the user (e.g., through a peer mobile device), and so forth.

In an example, a user can be party to a telephone conversation where a trip to Resort R is being discussed. The user can for example shake the phone during the conversation to trigger a context bookmark. The context bookmark can include information relating to the conversation about Resort R. This information about Resort R can be treated similar to an ambition in that it can be leveraged in relevancy determinations. This can occur automatically or at the further initiation of the user. Continuing the example, where the context bookmark is automatically incorporated, later advertisements related to Resort R vacation packages can be, for example, considered more relevant and made accessible to the user. Alternatively where the bookmark is user initiated, the user can select the bookmark to gather relevant content.

An additional example can be that a user is in a film and is partial to the shoes of an actor. The user can trigger a context bookmark. The bookmark can include data related to the context of the user, e.g. the movie being viewed and the particular scene being shown near in time to when the bookmark was formed. This information can be parsed to facilitate additional data acquisitions. In an instance, the movie scene can be compared against a database of products placed in the movie to acquire data relating to all clothing, shoes, cars, real estate, jewelry, etc. In this example, the user can also have an implicit preference for the types of shoes in that scene such that the user is presented with a list of stores carrying that shoe and a web link to the manufacturer to gather additional information. Alternatively, the user can specifically select the shoes from the list of related information gathered relative to the contextual bookmark.

According to one aspect, a context bookmark can comprise an activity that shares a limited relationship with content tagged by the context bookmark activity. To illustrate by contrast, an activity related to content might comprise saving content to a file (activity) that a user determines is of interest to them. User interest and saving information are typically related. An unrelated activity, on the other hand, might comprise clicking a button on a cell phone (activity) when a cell phone user hears a radio advertisement pertinent to a current user ambition (content of interest), speaking a predetermined word to an audio recording device (activity) when an airline schedule meeting a user's travel concerns is observed (content), or a semi or unconscious physical reaction, such as widening eyelids, cocking an ear to listen, observed by a monitoring device (e.g. a video camera focused on the user and coupled with video recognition software—not depicted), when the user sees a billboard sign, television advertisement, score of a sports game, and so on.

One of skill in the art will appreciate that numerous selection techniques, including fully automatic, fully manual and combinations thereof can be employed to leverage contextual bookmarks and that all such techniques are within the scope of the disclosure. Contextual bookmark component 514 can facilitate relevancy determinations relative to contexts as indicated by a user. Where processors and memory continue to evolve it is clearly anticipated that these computations will become vastly improved utilizing the disclosure presented herein. One of skill in the art will recognize and appreciate that the limitations of current technologies should not so limit the full expression of the disclosed components of system 500. The examples given here are provided for illustration only and are not provided to limit the scope of the disclosed subject matter.

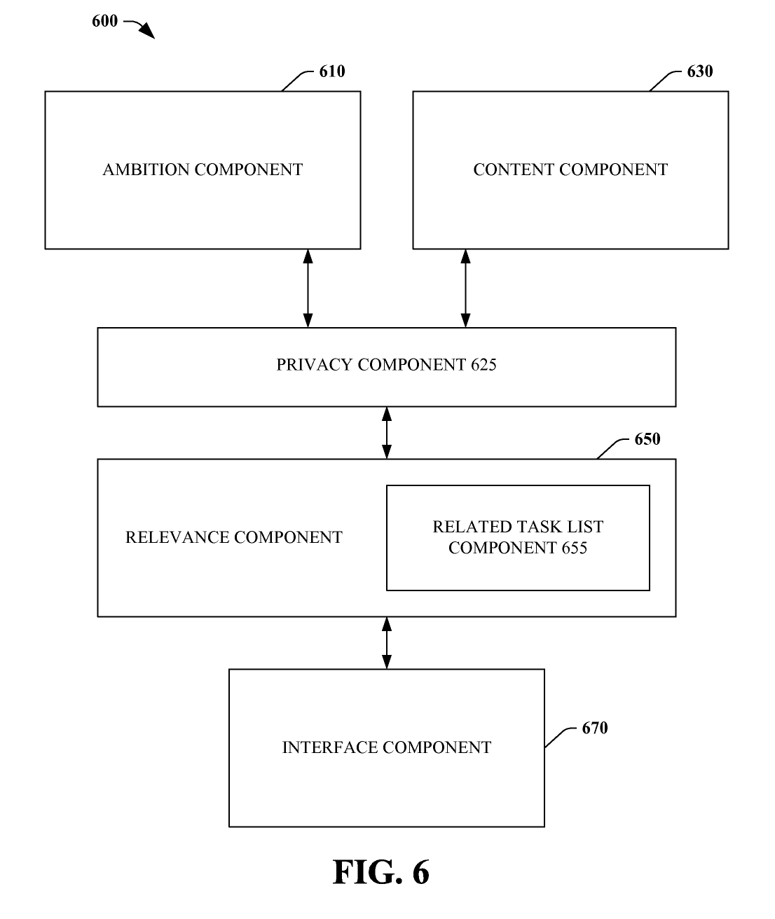

FIG. 6 illustrates a system 600 that facilitates access to information content based at least in part on relevancy to a user. System 600 can include ambition component 610 that can be similar to ambition component 510, 410, 210, 110 or task component 310 as disclosed herein. System 600 can further include a privacy component 625 that can be the same as 525, 425, 325 or 225; content component 630 that can be the same as or similar to content component 530, 430, 330, 230 or 130; relevance component 650 that can be the same as or similar to relevance component 550, 450, 350, 250 or 150; and interface component 670 that can be the same as or similar to interface component 570, 470, 370, 270 or 170 as disclosed herein.

System 600 can further include related task list component (RTLC) 655. RTLC 655 can be included within relevance component 650 (as illustrated) or can be a separate component of system 600 (not illustrated). RTLC 655 can facilitate access to information associated with lists of related tasks (e.g., ambitions) of the user.

Many user ambitions, whether explicit or implicit, can be related to other tasks or goals. These other tasks or goals can in an aspect be viewed as subsets related to the ambition. Accomplishing elements of these subsets can bring a user closer to achieving an ambition. Thus, the subsets can be highly relevant to a user to enable the user to achieve a goal. For example, where a user wants to build a deck on their home (e.g. an ambition) there can be a long list of associated tasks. These tasks can include permits, architectural drawings, bills of materials, finding contractors, arranging financing, etc. RTLC 655 can facilitate access to content associated with these related tasks. Continuing the example, RTLC 655 can facilitate presenting the user with a list of architects, scheduling a permit application appointment, links to deck designs and materials, articles on care of different decking materials, etc., that may not be directly considered relevant to the specific ambition of building a deck (e.g., where building a deck is considered strictly just construction of the deck itself.)

As another example, where a user plans a date, the RTLC 655 can suggest a flower shop to get a bouquet, a listing of restaurants that are appropriate for a romantic evening out, reviews of jazz bars to visit after dinner, or other related or complimentary information that is tangential to the specific ambition of the user (e.g. a dinner date). One of skill in the art will appreciate that numerous lists of tasks related to an ambition can be formed with varying levels of relatedness and that all such permutations of an RLTC 655 are within the scope of the disclosed subject matter.

As stated herein, relevance components 150 to 650 can further include an inference component or artificial intelligence component (not illustrated). An inference component can be an intelligent component. Further, an inference component can be included specifically in the relevance components themselves or be located elsewhere in the corresponding systems (also not illustrated). The inference component can be utilized to facilitate constructing, altering, and/or prioritizing user ambitions and/or relevance indicia, etc., based at least in part upon user activity and/or behavior. For example, the inference component can infer based on user behavior, user activity, data selection in relation to a user log, configuration settings for a particular user in accordance to user log data, ambitions, etc, that information content is more or less relevant to a user. For instance, user history indicia of a preference for French cuisine can result in an inference that reviews of a new local French restaurant can be of interest to the user.

It is to be understood that the inference component, as described, can provide for reasoning about or inference of states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

Generally, the user can interact with interface regions of the user interfaces (170 to 670) to select and provide information by way of various devices such as a mouse, a roller ball, a keypad, a keyboard, a touch interface, a gesture interface, a pen and/or voice activation, for example. Typically, a mechanism such as a push button or the enter key on the keyboard can be employed subsequent to entering the information in order to initiate an action. However, it is to be appreciated that the claimed subject matter is not so limited. For example, merely highlighting a check box can initiate an information conveyance. In another example, a command line interface can be employed. For example, the command line interface can prompt (e.g., by way of a text message on a display and an audio tone) the user for information by way of providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

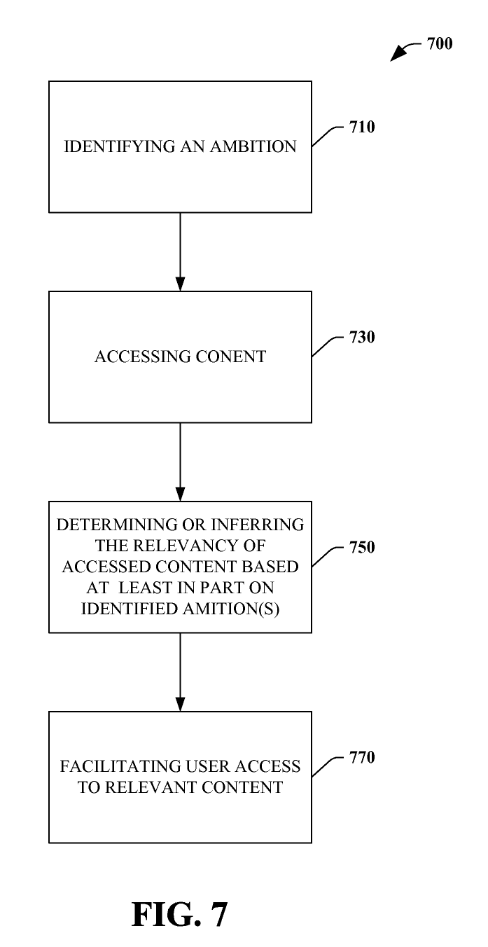

FIGS. 7-10 illustrate methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states by way of a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates an exemplary methodology 700 that facilitates accessing information content based at least in part on relevancy to a user. At 710, one or more subsets of user ambitions can be identified. These ambitions can be context sensitive goals, objectives, interests, to-do lists, calendar entries, other lists, etc., as described herein. These ambitions can be leveraged to facilitate determinations or inferences related to the relevancy of content to a user, as also disclosed herein, by execution of methodology 700.

Ambitions of a user can correlate strongly with the relevancy of content to a user. Where a user can define one or more ambitions, the ambitions can be leveraged in determinations of inferences related to determining the relevance of content made accessible to the user. These determinations or inferences of relevancy can be improved over determinations or inferences made without regard to user ambitions. For example, where a user is an omnivore but has made a goal of becoming a vegetarian, leveraging this goal in determining the relevancy of advertising for local restaurants can be a significant improvement in relevancy over ignoring this user goal. One of skill in the art will appreciate that any user ambition, from the most simple to the most complex, is within the scope of the disclosed subject matter regardless of the level of complexity. Further, one of skill in the art will appreciate that these ambitions can be leveraged in a plurality of ways to facilitate determinations or inferences related to the relevancy of content to a user and that all such methods are within the scope of the disclosed subject matter.

Further, as disclosed herein, dynamic adaptation of threshold relevancy levels can facilitate relevancy determination remaining relevant as context changes occur. It is foreseen that optimization of threshold relevancy levels in a dynamic manner can continue to improve over the years as improvements in computing and related technologies continue to improve the ability to manipulate highly complex modeling systems. These improvements fall within the scope of the disclosed subject matter.

At 730, content can be accessed in methodology 700. Content, as disclosed herein can be accessed from local, remote, or dispersed sources. Content can include, for example, audio and/or visual content, such as advertising, informational content, instructional content, entertainment content, or objects such as task, calendar, or to-do list objects. One of skill in the art will appreciate that as the number and quality of content increases, the ability to select relevant content rapidly increases and can typically be seen as being technologically limited, however, this disclosure also anticipates that as these technological hurdles are overcome (e.g., massive memories, voluminous connectivity, ultra fast processing . . . ) the value of selecting access to highly relevant content will improve dramatically. Thus, one of ordinary skill in the art will appreciate that all permutations of content are with the scope of the disclosed subject matter.

At 750 the relevancy of content to a user can be determined or inferred. In an aspect this determination or inference of relevancy can be related to the identified ambition from 710. As disclosed herein, the relevancy determination or inference is expected to be improved where user ambitions are considered. At 770, a user can access content based at least in part on the relevancy determination of 750. At this point methodology 700 can end.

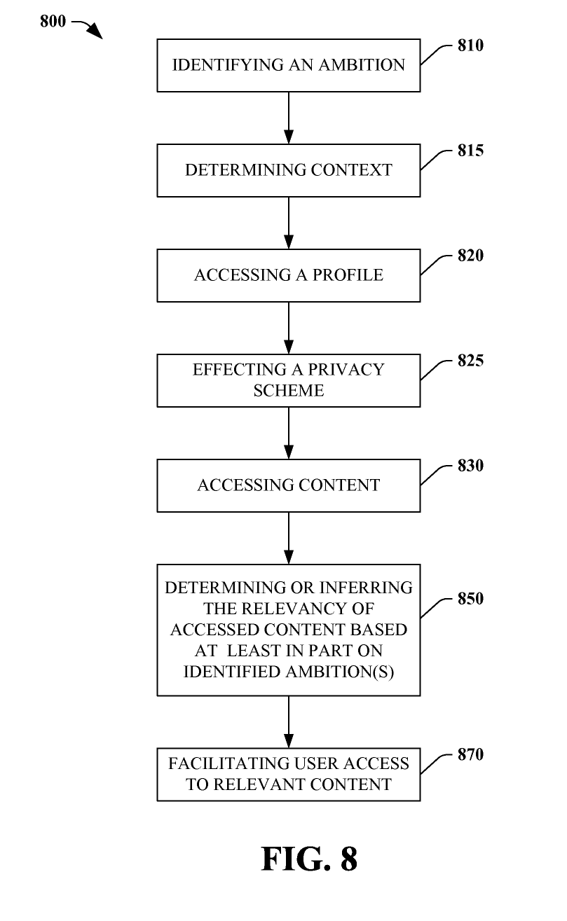

FIG. 8 illustrates an exemplary methodology 800 that facilitates accessing information content based at least in part on relevancy to a user. At 810 a user ambition can be identified. At 815, a user context can be determined. User context, as disclosed herein, can include physical context, spatial context, computing context, content context, combinations thereof, or other contexts relevant to determining the relevancy of content to a user. An example illustrated herein determines the context of a user to be related to a particular scene in a movie such that the product placements in that scene can be leveraged for relevancy determinations. One of skill in the art will appreciate that determining context can assume many forms and that all such forms are within the instant scope of the disclosure. At 820, a user profile can be accessed. The user profile can contain data that facilitates determinations of relevancy as disclosed herein. One of skill in the art will appreciate that user profiles can be leveraged in relevancy calculus and all such uses of a user profile fall within the scope of the disclosure.

At 825, a privacy schema can be effected to facilitate user privacy. At 830, content can be accessed. At 850, the relevancy of content to a user can be determined or inferred. Block 850 can be the same as or similar to block 750 of methodology 700. Further, block 850 can include considerations of the determined context from 815, the profile at 820, and the privacy schema of 825. Methodology 800 can thus facilitate a user accessing relevant advertising content based on indicia that can be highly relevant to the user's defined profile, context, and privacy concerns in concert with relevance to the user's ambitions. At 870, a user can be presented or given access to content based at least in part of the relevancy determination of block 850. At this point methodology 800 can end.

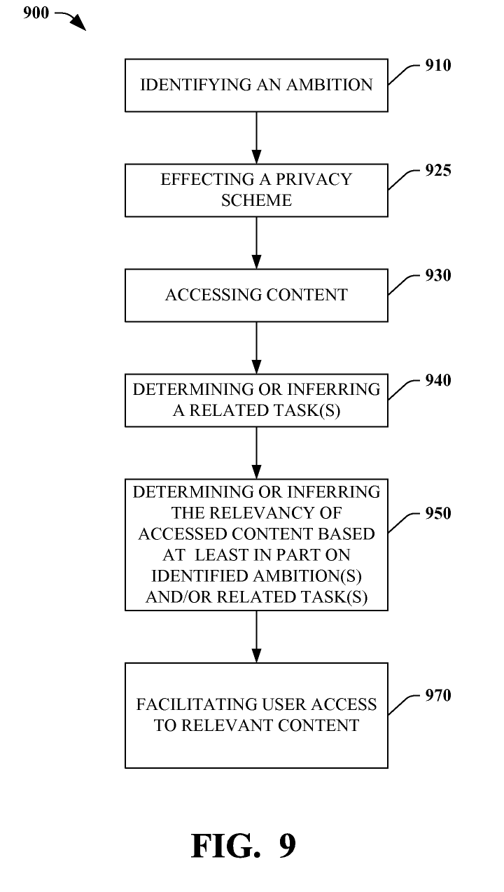

FIG. 9 illustrates an exemplary methodology 900 that facilitates accessing information content based at least in part on relevancy to a user. At 910, a user ambition can be identified. At 925, a privacy schema can be effected to facilitate user privacy. At 930, content can be accessed. At 940, tasks related to the identified user ambition of 910 can be determined or inferred. The related tasks can be the same as or similar to those described herein in relation to the systems of the disclosure. In an aspect, these related tasks are supplemental task lists, subsets of task lists, complimentary task lists, combinations thereof, or other groups of items related to the user's ambitions that can be further leveraged to improve relevancy analysis. For example, where a user wants to travel abroad, related tasks can be suggested to the user such as immunizations, information on activities in layover cities, key foreign language terms can be suggested to the user to learn before departing, etc. One of skill in the art will appreciate that numerous ancillary tasks can be inferred to facilitate relevancy determinations for content to provide additional support to a user in achieving an identified ambition.

At 950, the relevancy of content to a user can be determined or inferred. At 970, a user can access content based at least in part on the relevancy determination of 950 based in part on the ambition at 910 and the related task(s) at 940. At this point methodology 900 can end

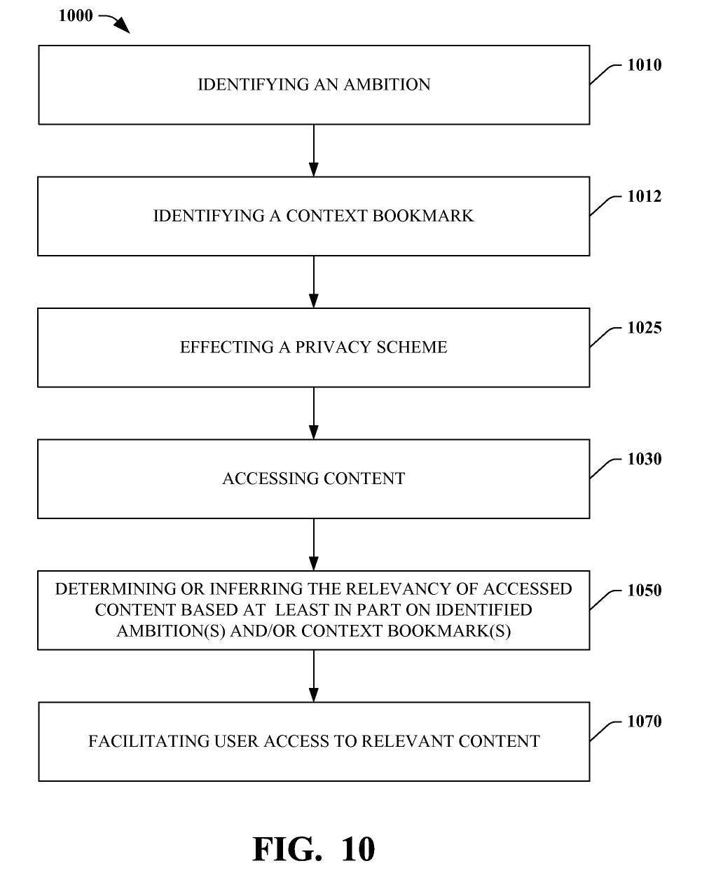

FIG. 10 illustrates an exemplary methodology 1000 that facilitates accessing information content based at least in part on relevancy to a user. At 1010, a user ambition can be identified. At 1012, a context bookmark can be identified. A context bookmark can be the same as or similar to the context bookmark disclosed in relation to the systems of the disclosed subject matter. A context bookmark can facilitate a user indicating a particular context from which additional relevancy indicia can be taken. For example, a context bookmark can be initiated as a user surfs the web, such that data related to the page the user was viewing is incorporated into determinations of relevancy. For instance, the user can context bookmark a photo of a sports car on the web, and based on historical views of sports cars, it can be inferred that the user desires more information about the car in the context bookmark. Based at least in part on this inference, the content related to that car can be determined to be of higher relevance and pushed to the user.

At 1025, a privacy schema can be effected to facilitate user privacy. At 1030, content can be accessed. At 1050, the relevancy of content to a user can be determined or inferred. At 1070, a user can access content based at least in part on the relevancy determination of 1050 based in part on the ambition at 1010 and the contextual bookmark at 1012. At this point methodology 1000 can end

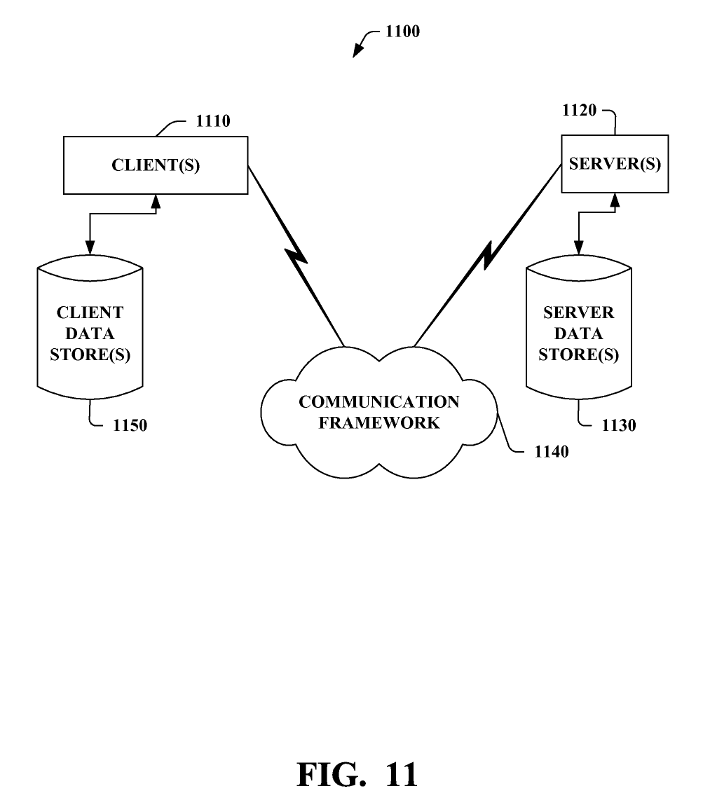

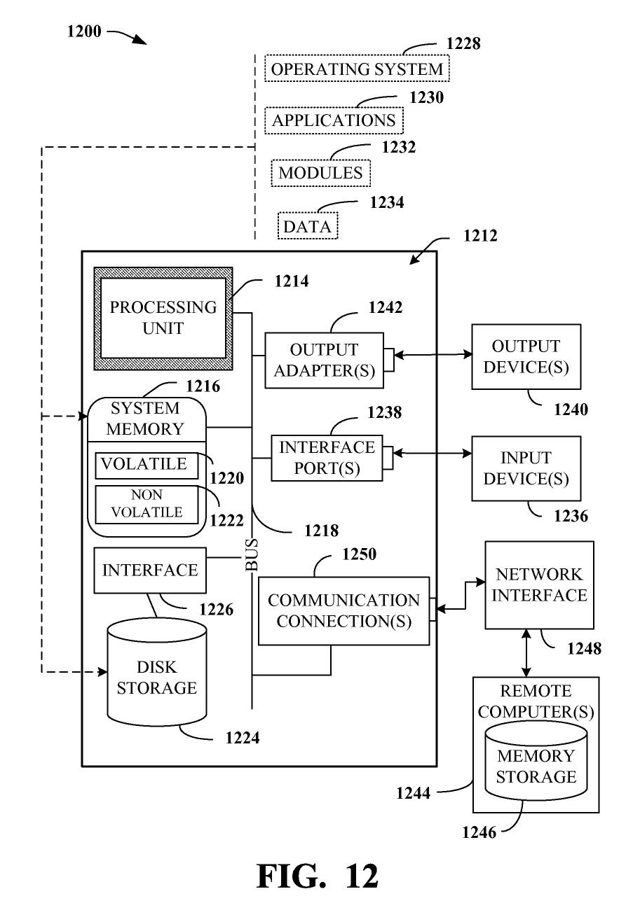

In order to provide additional context for implementing various aspects of the claimed subject matter, FIGS. 11-12 and the following discussion is intended to provide a brief, general description of a suitable computing environment in which the various aspects of the subject innovation may be implemented. For example, an ambition component, as described in the previous figures, can be implemented in such suitable computing environment. Where the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 11 is a schematic block diagram of a sample-computing environment 1100 with which the claimed subject matter can interact. The system 1100 includes one or more client(s) 1110. The client(s) 1110 can be hardware and/or software (e.g., threads, processes, computing devices). The system 1100 also includes one or more server(s) 1120. The server(s) 1120 can be hardware and/or software (e.g., threads, processes, computing devices). The servers 1120 can house threads to perform transformations by employing the subject innovation, for example.

One possible communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1150 that can be employed to store information local to the client(s) 1110. Similarly, the server(s) 1120 are operably connected to one or more server data store(s) 1130 that can be employed to store information local to the servers 1120.

With reference to FIG. 12, an exemplary environment 1200 for implementing various aspects of the claimed subject matter includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable programmable ROM (EEPROM), or flash memory. Volatile memory 1220 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in the suitable operating environment 1200. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the claimed subject matter can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems, FIOS modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system having a user interface that facilitates access to a selection of content, comprising:
an ambition component that facilitates identification of an ambition for a user of the system and importance of the ambition based on an explicit or implicit context of the user;
a content component that provides access to at least an information content datum calculated to be pertinent to the identified ambition or context;
a relevance component that ranks relevance of the information content with respect to the user ambition and importance thereof, orders relevant information content by relevance rank and establishes a threshold relevance for user access; and
at least one interface component to facilitate access to the relevant content if the calculated pertinence exceeds the threshold relevance.

2. The system of claim 1, wherein the relevance of the information content to the user is based on a deterministic analysis of relevance, an inferential analysis of relevance, or a combination thereof.

3. The system of claim 2, wherein the relevance analysis is further based at least in part on the physical context of the user, informational context of the user, temporal context of the user, or a combination thereof.

4. The system of claim 2, wherein the relevance analysis is further based at least in part on user profile indicia.

5. The system of claim 2, wherein the relevance analysis is further based at least in part on data related to an identified user ambition and the importance is specified as a must-do nature, a should-do nature, a can-do nature, a may-do nature, a could-do nature or a don't-want-to-do nature, or a combination thereof.

6. The system of claim 2, wherein the relevance analysis is further based at least in part on data related to a task ancillary to an identified user ambition.

7. The system of claim 1, wherein the content component further comprises at least one memory store wherein at least some content is stored and wherein the at least one memory store is local, remote, distributed, or a combination thereof with regard to a user device component.

8. The system of claim 1, further comprising at least one privacy component.

9. The system of claim 8, wherein the content component is communicatively coupled to the relevance component by way of a communications framework such that data is subject to privacy constraints related to the privacy component.

10. The system of claim 9, wherein the privacy constraints restrict information exchange by at least one of:
defining a permission level allowing personal information to be employed when it is stored on a host device for accessing relevant content;
defining a permission level allowing personal information to be employed when it is shared with entities so authorized for said sharing in relation to accessing relevant content;
defining a permission level allowing personal information to be employed when the personal information is first transformed via a k-anonymity requirement or an epsilon differential function to make the information anonymous before employing the personal information in a manner related to accessing relevant content; or
employing an algorithm to restrict transfer of malware to the content component or relevance component.

11. The system of claim 1, further comprising a context bookmark component to facilitate user indication of a contextually relevant event.

12. The system of claim 11, wherein the context bookmark component provides access to contextual data related to the user indicated contextually relevant event such that the accessed contextual data is available for relevancy analysis.

13. The system of claim 12, wherein the contextual data is indicated to be relevant by a defined user activity having limited relatedness to the contextual data, or by a user mannerism mapped to a sentiment of relevance to the user.

14. The system of claim 11, wherein the contextual data related to the user indicated contextually relevant event includes physical context data, temporal context data, information context data, or combinations thereof.

15. A computer-implemented method that facilitates accessing information content based at least in part on relevancy to a user, comprising:
identifying from a user context at least one set of data related to an identified user ambition;
accessing at least some information content while mitigating access to the at least one set of data;
determining the relevancy of the accessed content to a user based at least in part on the identified ambitions; and
facilitating user access to the relevant information content if the relevancy exceeds a minimum threshold.

16. The method of claim 15, wherein the relevancy analysis is further based at least in part on at least one of physical context of the user, temporal context of the user, informational context of the user, a user profile or combinations thereof.

17. The method of claim 15 further comprising effecting at least a privacy schema to protect user sensitive information.

18. The method of claim 15, further comprising determining at least one ancillary task related to a user ambition and wherein the relevancy analysis is further based at least in part on the determined at least on ancillary task.

19. The method of claim 15, further comprising identifying at least one user indicated contextual bookmark and wherein the relevancy analysis is further based at least in part on information related to the contextual bookmark.

20. A computer-implemented system that pushes relevant information content to a user by way of a user interface device, comprising:
a set of data objects representing one or more user ambitions;
a content source that comprises at least a set of information content that can be accessed by the user by way of the user interface device;
a relevancy determination engine that determines the relevancy level of content of the content source to the user based at least in part on the sets of data objects representing the one or more user ambitions; wherein content having a relevancy level exceeding a threshold level is pushed to the user by way of the user interface device; and
a contextual component that dynamically adjusts the threshold relevancy level in response to the current context of the user based at least in part on context determinations related to the user interface device.
